(19) United States
(12) Patent Application Publication
(10) Pub. No.: US 2009/0170152 A1
(43) Pub. Date: Jul. 2, 2009

(54) Tissue Conditioning Protocols

(75) Inventors: Ryan Reeser, Tucson, AZ (US); Brian H. Kram, Tucson, AZ (US); Vincent R. Rizzo, Indianapolis, IN (US); David Chafin, Tucson, AZ (US); Jerome W. Kosmeder, Tucson, AZ (US); Christopher Bieniarz, Tucson, AZ (US)

Correspondence Address: Runyan Law;C/O Intellevate LLC, P.O. Box 52050, Minneapolis, MN, 55402, US

(73) Assignee: Ventana Medical Systems, Inc., Tucson, AZ (US)

(21) Appl. No.: 12/344,564

(22) Filed: Dec. 28, 2008

Related U.S. Application Data
(63) Continuation-in-part of application No. 11/720,705, filed on Jun. 1, 2007.

(51) Int. Cl. G01N 1/28

(52) U.S. Cl. 435/40.52

(57) ABSTRACT

Solutions exhibiting little or no evaporative loss at elevated temperatures, i.e., in excess of 100° C., are employed in place of conventional aqueous-based antigen retrieval solutions.

### RELATED APPLICATION DATA

This claims the benefit of U.S. utility patent application Ser. No. 11/720,705, filed on 14 Dec. 2005, which application claims the benefit of U.S. provisional application No. 60/637,245, filed on 17 Dec. 2004; all of these applications are hereby incorporated by reference in their entirety.

### FIELD

The present invention relates to the processing of tissue samples, and more particularly to methods, materials, and apparatus for processing of preserved tissue samples. The invention description particularly references processing of embedded biological tissue samples for staining and will be in connection with such utility, although other utilities are contemplated.

### BACKGROUND

### Summary of the Related Art

The diagnosis of disease based on the interpretation of tissue or cell samples taken from a diseased organism has expanded dramatically over the past few years.

In addition to traditional histological staining techniques and immunohistochemical assays, in situ techniques such as in situ hybridization and in situ polymerase chain reaction now help diagnose disease states in humans. Thus, there are varieties of techniques that can assess not only cell morphology, but also the presence of specific macromolecules within cells and tissues. Each of these techniques requires that sample cells or tissues undergo preparatory procedures that may include preserving the sample with chemicals. These chemicals include aldehydes (such as formaldehyde, glutaraldehyde), formalin substitutes, or alcohols (such as ethanol, methanol, isopropanol). Alternatively, the techniques require preserving the tissue sample by embedding it in inert materials such as paraffin, celloidin, agars, polymers, resins, or a variety of plastic embedding media (such as epoxy resins and acrylics). Other sample tissue or cell preparations require physical manipulation such as freezing (frozen tissue section) or aspiration through a fine needle (fine needle aspiration (FNA)). Regardless of the tissue or cell sample or its method of preparation or preservation, the goal of the technologist is to obtain accurate, readable, and reproducible results that permit the accurate interpretation of the data. One way to gather this data is to prepare the tissue or cells in a fashion that optimizes the results of the test regardless of the technique employed. In the case of immunohistochemistry and in situ techniques, this means increasing the amount of signal obtained from a specific probe (e.g., antibody, DNA, RNA, etc.). In the case of histochemical staining, it may mean increasing the intensity of the stain or increasing staining contrast.

Without preservation, tissue samples rapidly deteriorate. This deterioration quickly compromises their use in diagnostics. In 1893, Ferdinand Blum discovered that formaldehyde would preserve or fix tissue so that it could be used in histochemical procedures. The exact mechanisms by which formaldehyde acts in fixing tissues are not well known, but probably involve cross-linking of reactive sites within and between protein molecules via methylene bridges (Fox et al., J. Histochem. Cytochem. 33: 845-853 (1985)). Recent evidence suggests that calcium ions also may play a role (Morgan et al., J. Path. 174: 301-307 (1994)). Some links cause changes in the quaternary and tertiary structures of proteins, but the primary and secondary structures appear to be preserved (Mason et al., J. Histochem. Cytochem. 39: 225-229 (1991)). The extent to which the cross-linking reaction occurs depends on conditions such as the concentration of formalin, pH, temperature, and length of fixation (Fox et al., J. Histochem. Cytochem. 33: 845-853 (1985)). Some antigens, such as gastrin, somatostatin, and α-1-antitrypsin, may be detected after formalin fixation, but for many antigens, such as intermediate filaments and leukocyte markers, immunodetection after formalin treatment is lost or markedly reduced (McNicol & Richmond, Histopathology 32: 97-103 (1998)). Loss of antigen immunoreactivity is most noticeable at antigen epitopes that are discontinuous, i.e., where the formation of the epitope depends on the confluence of portions of the protein amino acid sequence that are not contiguous.

Antigen retrieval refers to the attempt to “undo” the structural changes that tissue preserving processes induced in the antigens resident within that tissue. Although there are several theories that attempt to describe the mechanism of antigen retrieval (e.g., loosening or breaking of crosslinks formed by formalin fixation), it is clear that modification of protein structure by formalin is reversible under conditions such as high-temperature heating. It is also clear that several factors affect antigen retrieval: amount of heating, pH, molarity, and metal ions in solution (Shi et al., J. Histochem. Cytochem. 45: 327-343 (1997)).

Target retrieval is the attempt to recover nucleic acid sequences for analysis.

Heating appears to be the most important factor for retrieving antigens masked by formalin fixation. Different heating methods have been described for antigen retrieval in IHC such as autoclaving (Pons et al, Appl. Immunohistochem. 3: 265-267 (1995); Bankfalvi et al., J. Path. 174: 223-228 (1994)); pressure cooking (Miller & Estran, Appl. Immunohistochem. 3: 190-193 (1995); Norton et al., J. Path. 173: 371-379 (1994)); water bath (Kawai et al., Path. Int. 44: 759-764 (1994)); microwaving plus plastic pressure cooking (U.S. Pat. No. 5,244,787; Pertschuk et al., J. Cell Biochem. 19(suppl.): 134-137 (1994)); and steam heating (Pasha et al., Lab. Invest. 72: 167A (1995); Taylor et al., CAP Today 9: 16-22 (1995)).

Many solutions and methods are used routinely for staining enhancements. These include distilled water, EDTA, urea, Tris, glycine, saline, and citrate buffer. Solutions containing a variety of detergents (ionic or nonionic surfactants) may also enhance staining under a wide range of temperatures (from ambient to 100 degrees C. or greater.).

Tissues and cells are also embedded in a variety of inert media (paraffin, celloidin, OCT™, agar, plastics, or acrylics etc.) to help preserve them for future analysis. Many of these inert materials are hydrophobic, and the reagents used for histological and cytological applications are predominantly hydrophilic. Therefore, testing may require prior removal of the inert medium from the biological sample.

For example, testing paraffin-embedded tissue sections frequently requires removal of the paraffin from (de-waxing) the tissue section by passing the slide through various organic solvents such as toluene, xylene, limonene, or other suitable solvents. These organic solvents are very volatile causing problems that require special processing (e.g., traditionally de-waxing is performed in ventilated hoods) or special waste disposal. The use of these organic solvents increases the analysis cost and exposure risk associated with each tissue sample tested and has serious environmental effects.

Prior art retrieval methods require heating for a period under specific conditions. For example, immunohistochemical (IHC) primary antibody incubations can be 16 minutes or greater at 42 degrees C.; tissue conditioning takes place at 100-120 degrees C. for several minutes or more; and in-situ hybridizations take place at 47 degrees C. or greater for 1 hour or more. Because of these requirements, fluid retention and conservation is necessary to prevent fluid loss. Many applications have practiced various fluid retention schemes. For example, pressure vessels may be used to attain 120 degrees C. for tissue conditioning processes. Some applications use steaming vessels; the larger steaming container minimizes evaporation from the system while retaining appropriate fluid contact in the slide's vicinity. Humidified incubation chambers along with specialized hybridization coverslip devices have been used for manual in situ hybridization, which also operate by minimizing evaporation in the slide's vicinity. One manufacturer uses relatively large slide volumes (flooding) with a closed chamber to control evaporative losses.

All such prior art schemes entail system design complexities or limitations. For example, 120 degrees C. processing requires pressure vessel containment limiting easy integration with downstream IHC processing in a single platform.

Neither can 100 degrees C. steam processing be readily integrated without significant fluid-retention design requirements. Microwave processing and sonication entail instrumentation complexities of their own, significantly challenging downstream IHC and ISH integration. Generally, higher temperatures cause larger evaporation losses, which challenge fluid retention schemes.

Operating too close to the boiling point of the retrieval solution also causes “fluidic instabilities”. Fluidic instabilities manifest in a number of ways. First, solvent evaporation causes the solution to concentrate and the tissue potentially to dry. Second, dissolved gases come out of solution as temperature rises for many liquid systems. Entrained gas bubbles can prevent exposure of the tissue to solution leading to insufficient treatment and inconsistent staining. Third, the solution may locally boil at hot spots. Boiling and entrained or nucleated gas bubbles in or around tissue causes morphological damage. For all these reasons, retrieval processes involve various measures to protect against fluidic instabilities. Processes that substantially avoid fluidic instabilities are sometimes called fluidically stable or described as exhibiting fluidic stability.

Pressure chambers have been used to control fluidic instabilities by preventing solution loss. Also, pressure chambers allow aqueous solutions to superheat to above the boiling point of the solution (e.g. 126 degrees C) for accelerated processing. While such a process serves to achieve retrieval in only a few minutes, substantial time is still consumed with sample loading, apparatus heating, apparatus cooling, and sample unloading. Also, high pressure processing can be dangerous if high pressure steam inadvertently escapes. Furthermore, incorporating a pressure vessel into an automated integrated system, which otherwise provides reliable, cheap, simple, and small-footprint processing, is not practical.

In another example, antigen retrieval may use a steamer to contain the sample slides. The issues and difficulties are similar to those of the high-pressure steam. Because the process is performed at 100 degrees C. rather than 126 degrees C., it generally takes one-half hour instead of a few minutes to condition the tissue with this method not counting (un)loading and heating equilibration times.

What is needed is a method, tissue conditioning fluid chemistry, and apparatus that does not exhibit fluidic instabilities, carries out antigen or target retrieval in only a few minutes, has short heating and cooling times, does not require complex instrumentation to manage fluids or control temperature, does not consume large volumes of fluids, and does not require separate, time consuming de-waxing processes.

### SUMMARY

The invention comprises methods including mounting a preserved tissue sample near a capillary gap that receives a tissue conditioning fluid to allow a tissue conditioning reaction to occur for a reaction time at a reaction temperature. The tissue conditioning reaction prepares the preserved tissue sample for follow-on processing for analyzing the proteins or nucleic acids in the preserved tissue sample, e.g. provides antigen retrieval or target retrieval from the preserved tissue sample.

Some tissue conditioning reactions run at temperatures from 100-160 for times from 1 to 30 minutes. Some invention embodiments run the tissue conditioning reaction at ambient pressure, some without using a pressure containment vessel.

Some embodiments use high boiling point, low vapor pressure tissue conditioning fluids. The fluids or mixtures exhibit minimal fluid loss or loss in fluid volume during the tissue conditioning reaction.

In some of these embodiments, the tissue conditioning fluid comprises one or more chaotropic agents.

Further embodiments provide methods that condition the preserved tissue sample by carrying out antigen retrieval and target retrieval during the same process, in some cases, with the same retrieval fluid.

Additionally, the invention pertains to compositions of matter adapted for tissue conditioning that comprise or consist essentially of water (10% (v/v) or less), propylene glycol, and an amount of guanidinium thiocyanate to give the composition an overall 2-3 molar concentration of guanidinium thiocyanate.

### BRIEF DESCRIPTION OF THE DRAWINGS

Further features and advantages of the present invention will be seen from the following detailed description, taken with the accompanying drawings.

FIG. 1 is a block diagram of an apparatus useful in practicing the present invention.

FIGS. 2-4 are graphs illustrating antigen retrieval in accordance with the present invention.

FIGS. 5A and 5B are views similar to FIG. 1 of alternative forms of apparatus useful in practicing the present invention.

FIGS. 6A and 6B are photographs of a tissue sample stained using XT protocol available from Ventana Medical Systems. FIG. 6A was not tissue conditioned. FIG. 6B was tissue conditioned with propylene glycol and 3 molar guanidinium thiocyanate for 5 minutes at 95 degrees C. according to the present invention.

FIGS. 7A and 7B are photographs of a tissue sample stained to detect BCL-2 family of proteins. FIG. 7A was not tissue conditioned. FIG. 7B was tissue conditioned with propylene glycol and 3 molar guanidinium thiocyanate for 10 minutes according to the present invention.

FIGS. 8A and 8B are photographs of a tissue sample stained to detect a vimentin family of filament proteins. FIG. 8A was not tissue conditioned. FIG. 8B was tissue conditioned with propylene glycol and 3 molar guanidinium thiocyanate for 10 minutes according to the present invention.

FIG. 9 is a photograph of a tissue sample processed with IHC and ISH protocols after the tissue was tissue conditioned with propylene glycol and 2 molar guanidinium thiocyanate for 5 minutes at 140 degrees C. according to the present invention.

FIG. 10 is a photograph of a tissue sample processed with IHC and ISH protocols after the tissue was tissue conditioned with propylene glycol and 2 molar guanidinium thiocyanate for 5 minutes at 140 degrees C. according to the present invention.

### DETAILED DESCRIPTION

The following description of several embodiments describes non-limiting examples that further illustrate the invention. All titles of sections contained herein, including those appearing above, are not to be construed as limitations on the invention, but rather they are provided to structure the illustrative description of the invention that is provided by the specification.

Unless defined otherwise, all technical and scientific terms used in this document have the same meanings as commonly understood by one skilled in the art to which the disclosed invention pertains. The singular forms a, an, and the include plural referents unless the context clearly indicates otherwise. Thus, for example, reference to “fluid” refers to one or more fluids, such as two or more fluids, three or more fluids, or even four or more fluids. Likewise, reference to “a platen” refers to one or more platens such as two or more platens, three or more platens, or even four or more platens.

A sample refers to any sample obtained from, derived from, or containing any organism including a plant, an animal, a microbe, or even a virus. Particular examples of biological samples include tissue sections, cytology samples, sweat, tears, urine, feces, semen, pre-ejaculate, nipple aspirates, pus, sputum, blood, serum, tissue arrays, and protein and nucleic acid arrays. A preserved tissue sample is a tissue sample preserved by any one or more preservation techniques. One type of preservation technique is chemical preservation using, among other chemicals, aldehydes (such as formaldehyde, glutaraldehyde), formalin substitutes, or alcohols (such as ethanol, methanol, isopropanol). Another type of preservation technique is preservation by embedding the tissue sample in inert materials such as paraffin, celloidin, agars, polymers, resins, or a variety of plastic embedding media (such as epoxy resins and acrylics). Yet other preservation techniques employ physical manipulation such as freezing (frozen tissue section) or aspiration through a fine needle (fine needle aspiration (FNA)) on the sample tissue or cell preparations.

A liquid refers to any substance in a fluid state having no fixed shape but a substantially fixed volume. Examples of liquids include solvents and solutions. A liquid can be polar or non-polar, organic or inorganic, volatile or non-volatile, high viscosity or low viscosity, an emulsion or a true solution. Examples of fluids or liquids include water, alcohols, polyols, hydrocarbons and ionic liquids.

The present invention provides methods, materials and apparatus for antigen retrieval and target retrieval (also called tissue conditioning or simply retrieval) that overcome the disadvantages of the prior art.

The tissue conditioning processes use fluids to retrieve the target structural domain for a desired, follow-on analysis or to recover the ability to analyze the tissue sample.

### The Process

The process for tissue conditioning (or retrieval) typically starts with a de-wax process if the preserved tissue sample was mounted in wax, at least in those tissue conditioning processes that require a de-waxing step. Afterwards, the preserved tissue sample is treated with an amount of a tissue conditioning fluid (retrieval fluid), as described below, with a reaction temperature of greater than 100 degrees C. for a time (called a reaction time). Once treated with the tissue conditioning fluid, the tissue sample is optionally cooled or washed or both. That ends the retrieval process. Next, a follow-on analysis (immunohistochemical, in-situ hybridization, in situ PCR) can be performed on it with no or with diminished interference from the preserving methods previously carried out on the tissue to preserve it. Some invention embodiments provide the ability to forgo a de-waxing step.

### Tissue Conditioning or Retrieval Solutions or Fluids

Tissue conditioning fluids of the present invention should exhibit one or more of the following characteristics:
High boiling point
Low vapor pressure
Stable at reaction temperatures
Stable fluidically
Low viscosity

Some of these characteristics are related to each other and are placeholders for the functional requirements of the fluid. For instance, the fluid should behave at the retrieval reaction temperature such that a substantial amount of the fluid remains present during the reaction. One of ordinary skill in the art recognizes that the retrieval reaction, since it progresses with the tissue sample contacting a retrieval fluid, functions better if the tissue remains wet with the retrieval fluid. So, one aspect of “substantial amount” in this context is that enough fluid remains that the tissue sample remains wet throughout the reaction. How much fluid remains is a function of the vapor pressure of the fluid, the reaction time, and the reaction temperature, among other variables.

Likewise, one of ordinary skill in the art recognizes that the concentration of materials dissolved in the fluid should remain constant enough during the retrieval reaction such that changes in the concentration during the reaction do not cause substantial changes in the reaction chemistry. For instance, concentration changes that avoid chemical precipitation or avoid changes in reaction kinetics are small enough to not cause substantial changes in the reaction chemistry.

Therefore, a “substantial amount” means that enough fluid remains to keep the tissue wetted, to prevent chemical precipitation, or to avoid reaction kinetics changes. More specifically, a “substantial amount of the retrieval fluid remains” means that 50-100%, 60-100%, 80-100%, or 90-100% of the fluid remains at the end of the retrieval reaction. Put a different way, in some invention embodiments, the tissue conditioning fluid experiences a volume loss during the tissue conditioning reaction that is less than 50, 40, 20, or 10 percent by volume.

In addition to using tissue conditioning fluids that exhibit low volatility at elevated temperatures, the fluids of the present invention provide novel solution chemistries for retrieval that are fluidically stable at elevated temperatures, exhibit little or essentially no vapor pressure, can withstand heating and cooling rapidly to set point temperatures, do not need large fluid volumes, are effective using short reaction times, do not require complex instrumentation, and can be used without first de-waxing the sample.

Moreover, these low or essentially no vapor pressure liquid retrieval chemistries replace aqueous-based retrieval chemistries in some sets of invention embodiments.

The vapor pressure of a substance depends on the temperature and chemical structure of the substance. Generally, a liquid with a higher boiling point has a lower vapor pressure at any given temperature below boiling than a liquid with a lower boiling point. Tissue conditioning fluids that are liquid at room temperature and have boiling points above 200 degrees C., above 180 degrees C., or above 160 degrees C. are particularly useful in the present invention.

Likewise, viscosity depends on the temperature and chemical structure of the substance. In some embodiments, the tissue conditioning fluids have or also have viscosities less than about 300 centipoise at anticipated operating temperatures of 100-160 degrees C.

Vapor pressure and fluidic stability are also related. At reaction temperatures of 100-160 degrees C., these compounds have very low vapor pressures. Consequently, they exhibit fluidic stability in the desired temperature range for retrieval processing. Their propensity not to boil or evaporate at reaction temperatures translates into little or no cavitation from boiling or bubble formation.

The tissue conditioning fluid also should be compatible with chemicals used for staining, hybridization, etc., and capable of permitting the separation of paraffin used for embedding biological specimens. And, while the tissue conditioning fluid also should be capable of antigen retrieving the tissue specimens, it should have little or no other effect, i.e., morphological damage, on the tissue specimens.

The tissue conditioning fluids of the present invention protect the tissue samples from drying out and allow retrieval from the tissue at temperatures above paraffin's melting point of about 60 degrees C. In some sets of invention embodiments, the tissue conditioning fluid allows the paraffin to float and separate, thereby allowing the fluid to contact the tissue to cause retrieval without the tissue first undergoing a de-waxing process.

The material used as tissue conditioning fluids in accordance with the present invention may be used undiluted. But in order to reduce viscosity of certain materials, the material may be diluted with water or an organic solvent. But if diluted, the material should comprise the principal component at about 5 to about 75% by volume of the diluted solution. The material and diluent should be miscible or at least dissolve in one another within the proportions employed.

### Organic Solvent-Containing Fluid

Another class of particularly useful materials that satisfy these criteria are fluids that contain organic solvents. In some embodiments, the tissue conditioning fluid comprises aminopolyols, glycerol, ethylene glycol, propylene glycol, poly(ethylene glycol), poly(propylene glycol), aliphatic alcohols, and the like. In these or other embodiments, the tissue conditioning fluid comprises two or more fluids selected from the list set out above. Moreover, embodiments exist wherein the fluid is selected from a group of fluids that specifically excludes one or more of the fluid set out above. Also, the tissue conditioning fluid can comprise one or more of the fluids listed above combined with an amount of water.

One set of embodiments uses aminoglycols as components in the tissue conditioning fluid. Examples of aminoglycols useful in the practice of the present invention include 3-amino-1,2-propanediol, diethanolamine, and triethanolamine. As for organic solvents generally, the tissue conditioning fluid can comprise one or more of the aminoglycols listed above combined with an amount of water. Particularly useful in some sets of invention embodiments is 3-amino-1,2-propanediol diluted with deionized water to about 50% by volume.

Another class of useful materials are aminopolyols. Aminopolyols are low vapor pressure, high boiling point materials that include aminoglycols, i.e., aminopolyols displaying one amine and two hydroxyl groups attached to the carbon chain. Particularly useful are 3-amino-1,2-propandiol and diethanolamine with boiling points of 262 and 217 degrees C., respectively.

Propylene glycol with 2-3 molar guanidinium thiocyanate as a chaotropic agent (discussed more fully below) functions as a tissue conditioning fluid in some invention embodiments. As part of the tissue conditioning process, this material can cause antigen retrieval and target retrieval during the same process, alleviating the need to run the tissue sample through separate processes when the follow-on analyses require antigen retrieval and target retrieval pretreatment. Moreover, using a single tissue conditioning fluid simplifies equipment design in apparatuses that carry out the tissue conditioning because providing multiple condition fluids tailored to the different analyses can be avoided. Some invention embodiments carry on antigen retrieval either before or after target retrieval using the same tissue conditioning fluid or a different tissue conditioning fluid for antigen retrieval and target retrieval. Some invention embodiments carry out antigen retrieval only. Some embodiments carry out target retrieval only. And as discussed above, some invention embodiments carry out antigen retrieval and target retrieval at the same time.

Some invention embodiments employ tissue conditioning fluids that are non-aqueous. In some invention embodiments, non-aqueous means that the solution contains little enough water that the bulk solvating effect comes from the presence of a solvent other than water. Non-aqueous solutions, as used in this document, can include water and encompass solutions with less than 0.5, 1, 2, 5, 10, 20, 30, 40, or 50% water in the various embodiments of this invention.

### Organic Salt Fluid

Organic salts that normally are liquid at room temperature (ionic liquids) are another class of particularly useful materials that satisfy the criteria set out above. Because they are salts, they do not evaporate; hence, they exhibit very low vapor pressure and do not boil within the temperature range of interest between e.g., 100-160 degrees C. In some sets of invention embodiments, the tissue conditioning fluid comprises an organic salt that is normally liquid at room temperature and has a boiling point in excess of about 200 degrees C. An organic salt is a salt that contains an organic ion. Examples of organic salts useful in the practice of the present invention include organic borates such as 1-butyl-4-methylpyridium tetrafluoroborate, organic sulfates such as 1-butyl-3-methylimidazolium 2-(2-methoxy ethoxy) ethyl sulfate, and organic phosphates, which are normally liquid at room temperature and have a boiling point in excess of about 200 degrees C.

### Chaotropic Agents

Some embodiments employ tissue conditioning fluids that comprise chaotropic agents. For purposes of this disclosure, chaotropic agents are materials that disrupt a three-dimensional structure of macromolecules such as proteins, DNA, RNA, etc. Moreover, the chaotropic agent frequently denatures the macromolecule. In some embodiments, the chaotropic agent is one of I⁻, ClO₄⁻, SCN⁻, Li⁺, Mg²⁺, Ca²⁺, Ba²⁺, and Gu⁺.

### Reaction Temperature

In some invention embodiments, preheated heating stations that are suitable for contacting slides for rapid heating or cooling are used. As a result, heating and cooling times associated with prior art heater reequilibration may be avoided resulting in faster slide processing. And once processed, slides wetted with low vapor pressure fluids of the present invention can sit for long times before follow-on operations without risking drying the tissue sample.

In some sets of invention embodiments, the tissue conditioning fluid is preheated before being applied to the slide. Preheating the tissue conditioning fluid facilitates slide processing and, in the case of viscous fluids, also facilitates fluid transport. The surface(s) that receives the tissue conditioning fluid may be preheated before fluid is applied and the slide contacted. The preheated surface may be used to preheat the fluid before slide contacting. Because of preheating, the heating and cooling times associated with the slide heater returning to thermal equilibrium may be decreased permitting retrieval in a short time and permitting faster slide processing. In some sets of embodiments, slides are contacted with preequilibrated temperature surfaces or environments in place of driving the coupled slide plus slide temperature-controlled station back and forth between temperatures.

In these or other embodiments, the slides can be removed after processing with no or substantially no cooling of the apparatus thereby avoiding most reaction time related to changing temperature as is conventionally seen.

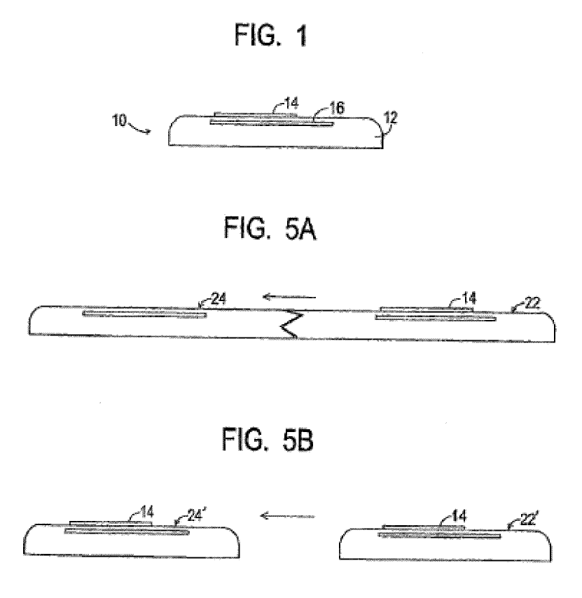

Referring to FIG. 1, the apparatus 10 comprises a slide holder 12 for supporting slides 14 and slide heaters 16 designed to operate at elevated temperatures, i.e., 100-160 degrees C.

### Reaction Time

For purposes of this document, reaction time or time of the retrieval reaction is measured beginning at the time the sample contacts the tissue conditioning fluid and ends when the heat or the conditioning fluid is removed from the tissue. The tissue sample may be removed from the heat source to remove the heat. The conditioning fluid may be removed by rinsing with another fluid.

### Tissue Conditioning

Tissue conditioning processes vary depending upon the sample type (including how the sample was preserved) and the intended analysis method(s) (such as immunohistochemical analysis, in situ hybridization analysis, in situ PCR analysis, or other analysis). In some embodiments, the “intended analysis method” is called a follow-on analysis. The protocols for these retrieval processes vary with respect to chemistry, reaction time, and temperature. Optimizing these protocols often focuses on the specific application. But frequently, application-specific optimization comes at the expense of standardization. This lack of standardization, especially with reaction time, prevents the processor software from being able to schedule the simultaneous completion of the multiple samples that the processor is treating (with different protocols). The lack of temporal standardization for the retrieval process complicates operational sequencing. Creating tissue conditioning processes or protocols with enough flexibility in chemistry, reaction temperature, etc., to allow successful retrieval along with more closely aligned protocol times would simplify operational sequencing.

In some invention embodiments, the use of low volatility retrieval solvents joined with higher reaction temperature provides enough flexibility in the protocol to align processing times more closely. In some embodiments, the use of a non-aqueous, high-boiling-point liquid allows for preheating of retrieval solutions. The slide containing the tissue sample can be processed using the preheated solution with or without separately heating the tissue sample. For instance, in some embodiments the preheated solution can be applied to the slide on a slide stage that has been preheated or the preheated solution can be applied to the slide on a cool slide stage that is then heated to the reaction temperature or the preheated solution can be applied to a slide such that any heating of the tissue sample is caused by the heat contained in the preheated solution, etc.

### Pressure

A hallmark of these fluids is their ability to be used in high-temperature tissue conditioning protocols without the need for pressure containment of the reaction. In some embodiments, the tissue conditioning process has a reaction pressure of ambient pressure or one atmosphere. In these or other embodiments, the tissue conditioning process uses an apparatus that prevents the reaction pressure from exceeding ambient pressure or one atmosphere.

### Microfluidics and Capillary Gap

The behavior of fluids typically constrained by either small volumes (sub milliliter) or small fluid pathways (sub several hundred micrometers) differ from the behavior of the fluids at a macroscopic level. This is believed to be because factors such as surface tension, energy dissipation, and fluidic resistance start to dominate the system. For purposes of this disclosure, the phrases “microfluidic process” or “implementing a microfluidic process” mean that the process contains or implements small enough volumes or fluid pathways such that surface tension, energy dissipation, or fluidic resistance substantially influence the behavior of the system.

In some invention embodiments, part of the tissue conditioning process involves implementing a microfluidic process. In these or other embodiments, implementing a microfluidic process comprises using an apparatus that includes a platen or a capillary gap or an air gap. A capillary gap is a gap between two or more surfaces that has an appropriate size to allow microfluidic effects to constrain the fluidic processes of the system. The gap can arise merely from constraining a small volume of fluid between two flat surfaces in such a way that the fluid's presence maintains the gap, or the gap can be built into a device that has a physical structure that holds two or more surfaces away from the others, but also holds them close enough to constrain the fluid. Methods of forming capillary gaps or spaces are within the skill of those of ordinary skill in the art. In some cases, the capillary gap is not bounded or is unbounded. This means that the “edges” of the fluid are not constrained by a solid structure, which facilitates the fluid's interaction with ambient pressure air. In embodiments with an unbounded capillary gap, the fluid (and the reaction occurring within the fluid) experiences ambient pressure.

In some embodiments, the platen is heated. This provides at least a portion of the energy needed to bring the system to the reaction temperature. In some embodiments, the (non)heated platen is adjacent the capillary gap. For the purposes of the document, adjacent the capillary gap means that the (non)heated platen contacts the outside of a wall of the capillary gap or serves as a wall of the capillary gap. In some embodiments, the (non)heated platen is adjacent the tissue sample. For purposes of this document, adjacent the tissue sample means that the platen contacts the sample or the material on which the sample is mounted. In some embodiments in which the platen is adjacent the sample, the sample is between the capillary gap and the platen.

### EXAMPLES

The invention will be further described with reference to the following examples. In the following examples, some automated examples are run on a DISCOVERY® autostainer available from Ventana Medical Systems, Inc., Tucson, Ariz.

### Example 1

### Ki67 on Tonsil on DISCOVERY® Autostainer Using Automated Antigen Retrieval

Tissue Block A contained a piece of paraffin-embedded, neutral-buffered, formalin fixed human tonsil. The block was micro-sectioned in approximately 4-micron thick sections, one section mounted per slide for ˜200 slides provided for testing. Tissue cross section diameter was approximately 1.0 cm. Slides had been stored for a minimum of ˜1 month and so were effectively dried and adhered to the glass. Slides were de-waxed off-line in xylenes and graded alcohols and thoroughly rinsed with de-ionized water. Antigen Ki-67 was selected for testing retrieval characteristics because it is known to be masked by formalin fixation. Hematoxylin counterstain was selected to improve visualization of tissue morphology. The following reagents were all obtained from Ventana Medical Systems, Inc., Tucson, Ariz.: Antibody CONFIRM™ anti-Ki67 (K-2 clone) catalogue #790-29 10; DAB MAP™ Kit cat #760-124; Universal Secondary Antibody P/N 760-4205; Hematoxylin P/N 760-2021; Bluing Reagent P/N 760-2037. All slides were processed on a Ventana DISCOVERY® autostainer according to standard or modified protocols performing automated de-wax plus antigen detection processes, except where otherwise noted.

Three slides were run (protocol “A”) on a Ventana DISCOVERY® autostainer with no tissue conditioning (antigen retrieval) processing. Two additional slides were run (per protocol “B”) with “standard” tissue conditioning selected.

Without tissue conditioning, no antigen was detected; no staining other than the counterstain was observed on any of the slides from this group. With tissue conditioning, Ki-67 antigen was clearly observed on all slides associated with and around germinal centers, indicating the efficacy and necessity of the tissue conditioning process in the recovery of the masked antigen. The staining intensity was classified as “dark” or maximally stained. Standard tissue conditioning involves 37 operational steps consuming 72 minutes of reaction time. Morphology between the two protocols looked essentially equivalent and was defined as “good”.

### Example 2

### Time Dependence of Antigen Retrieval

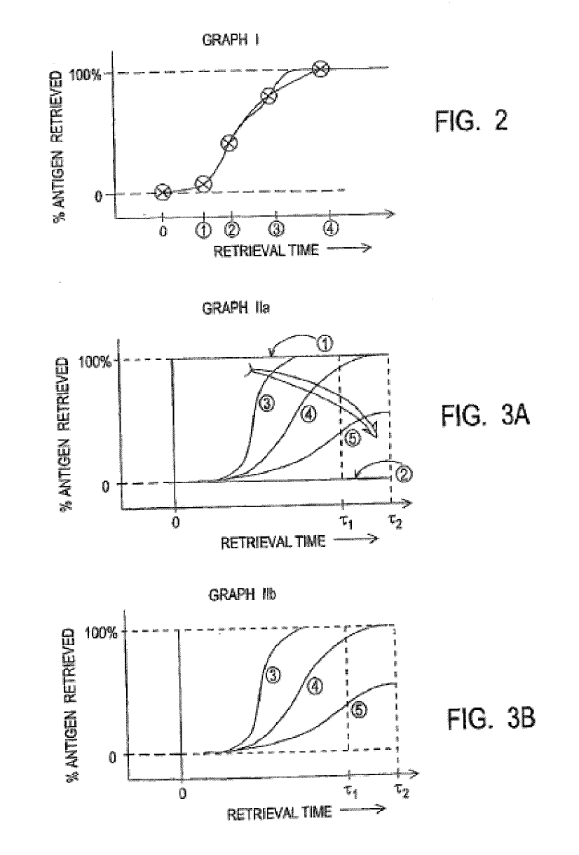

Tissue Block B contained a piece of paraffin-embedded, neutral-buffered, formalin-fixed human tonsil. Four slides each with a single tissue section were run at various conditions of antigen retrieval processing with nominal set point reaction temperature of 100 C: “Short”, “Mild”, “Standard”, and “Extended” protocols. All four protocols began with the same heat ramp processing taking ˜18 minutes. Short tissue conditioning total time was 24 minutes; Mild was 42 minutes; Standard was 72 minutes; and Extended was 102 minutes. Each condition therefore progressively exposed the tissue sample to greater antigen retrieval reaction times. Table 1, below illustrates the effect of retrieval time on observable stain intensity. Greater exposure time during antigen retrieval processes increases the degree of antigen retrieval as measured by observable detection, illustrated in Graph I as shown in FIG. 2.

TABLE 1

| Exposure Condition | Stain intensity |
|---|---|
| Short (24 min.) | ~0 |
| Mild (42 min.) | light |
| Standard (72 min.) | medium |
| Extended (102 min.) | dark |

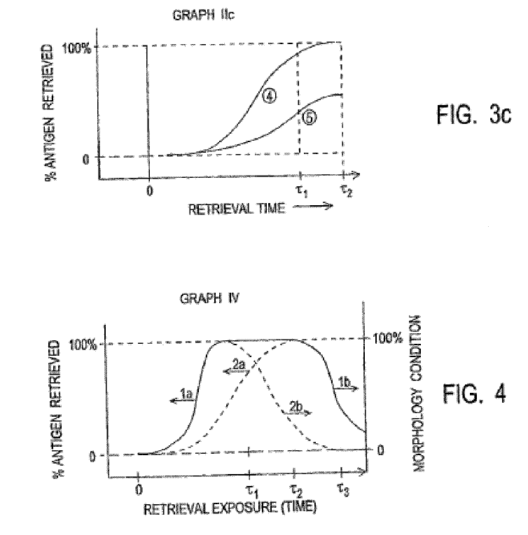

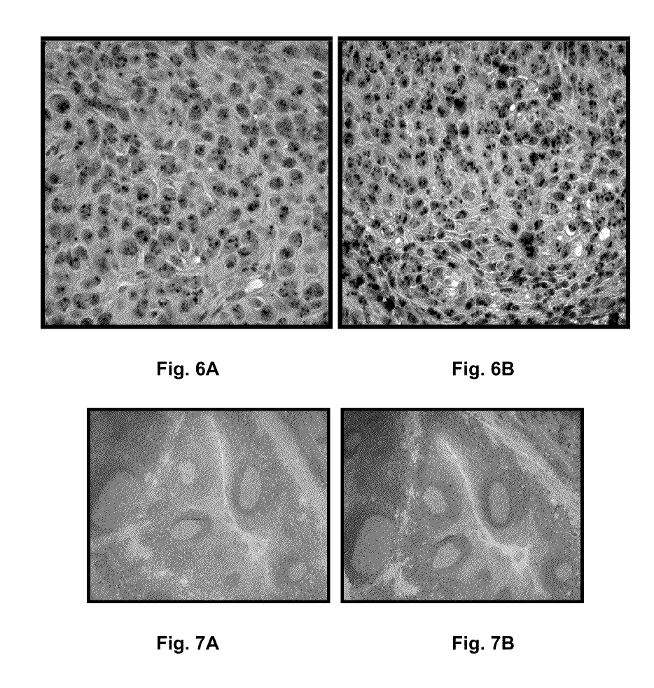

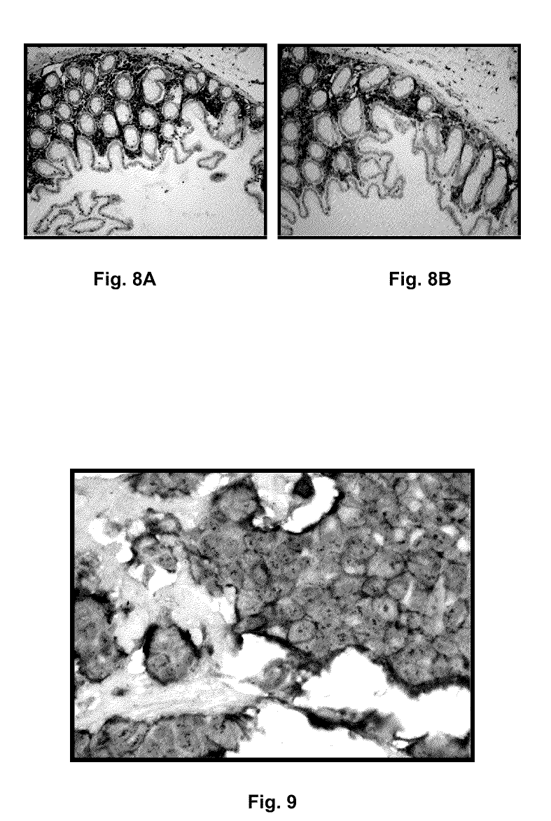

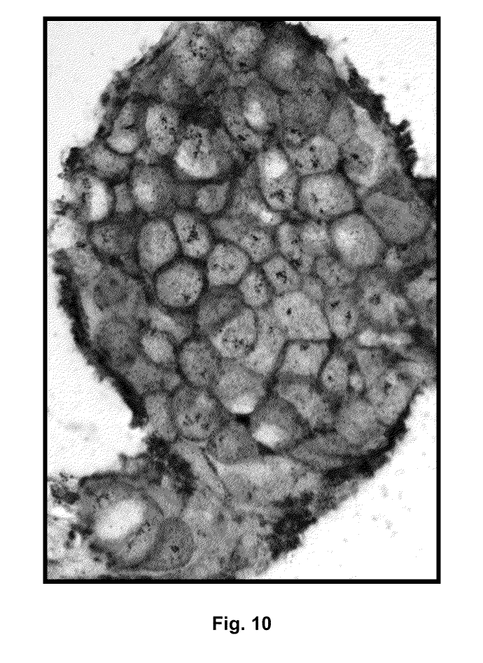

Block B demonstrates greater resistance to retrieval than Block A: Standard tissue conditioning process yielded dark staining for Block A and only medium staining for Block B. Graph IIa (FIG. 3a) illustrates this idealized relationship where Tissue Blocks A & B are represented by Curves 3 and 4, respectively. Curve 1 (FIG. 3a) represents the case where no retrieval is needed; the antigen is not masked and requires zero reaction time before 100% of available antigen is available for detection. Curve 2 (FIG. 3a) represents the case where the antigen is irrecoverably masked, or alternatively, the retrieval process is simply not effective; retrieval processing fails to restore any antigenicity. Curves 3 through 5 (FIG. 3a) represent progressive degrees of recoverability resistance of the masked antigen. Greater retrieval processing is required for certain cases with respect to others, purportedly because of variances in the tissue preparative operations.

### Example 3

### Temperature Dependence of Antigen Retrieval

Tissue Blocks B and C each contained a piece of paraffin-embedded, neutral-buffered, formalin fixed human tonsil. One slide each was stained using standard tissue conditioning and an additional slide was stained using the same protocol except that the tissue conditioning temperature was changed to 95 degrees C. and 90 degrees C. Results are reported in Table 2, below.

TABLE 2

| Temperature | Stain Intensity - | Stain Intensity - |
|---|---|---|
| deg C. | Tissue C | Tissue B |
| 100 | dark | medium |
| 95 | dark | light |
| 90 | medium | faint |

Tissue B required greater retrieval in order to recover an equivalent amount of antigen signal compared to Tissue C for each of the retrieval processes listed. Tissue morphology was good in all cases.

Three various retrieval processes are illustrated in Table 2, above differentiated by process temperature with various staining intensity results. Higher temperature provided greater antigen retrieval. Graph IIb (FIG. 3b) illustrates this temperature effect: Curve 3 represents the retrieval process at 100 degrees C.; Curve 4 at 95 degrees C.; Curve 5 at 90 degrees C. Higher temperature provided better antigen retrieval for this chemistry without adverse morphological consequences. Curve 3 (FIG. 3b) represents a maximum efficiency curve for this process because the aqueous tissue conditioning solution cannot be raised above its boiling point and remain in liquid phase. There are trade-offs, however, operating so near the maximum useable temperature. Protocol “B” illustrates the frequent fluid replenishing (12×) required to overcome fluid losses. For every replenishing, the operating slide volume temperature becomes depressed and requires time to recover. A large amount of fluid is consumed, which produces a fair amount of fluid waste.

### Example 4

### Chemical Conditioning Fluid versus Water in Antigen Retrieval

Antigen retrieval chemistries vary in efficacy of retrieval. Various tissue conditioning fluids were tested using various reaction times using the same protocols and compared to Ventana Medical Systems, Inc. cell conditioning fluid (CC1) a citrate buffer, at 100 degrees C. set point as a baseline. Two slides each were stained using de-ionized water in place of CC1 at Mild and Extended conditions. The H₂O Mild condition stain intensity was equivalent to the Short CC1 condition; the Extended H₂O staining was equivalent to the Mild CC1 condition. Morphology was good in all cases. Graph IIc (FIG. 3c) can be used to illustrate efficacy of retrieval processing based on specific chemistry. DI water as the antigen retrieval liquid is illustrated by Curve 5; CC1 chemistry by Curve 4. Preferred chemistries such as citrate buffer, therefore, decrease the antigen retrieval reaction time, or alternatively, are more effective at retrieving antigen for otherwise equivalent processing conditions.

### Example 5

### Low Vapor Pressure Antigen Retrieval Fluids at 100 degrees C.

Candidate fluids of the present invention were substituted in place of CC1 to test them for effective antigen retrieval. All candidates had low or no vapor pressure at 100 degrees C. This attribute permitted protocol simplification eliminating constant fluid replenishment. Instead, a single bolus of fluid was administered at the outset of antigen retrieval processing followed by immediately increasing the temperature to 100 degrees C. and holding it there. It took approximately 10 minutes to reach approximately 100 degrees C. in all cases. At the end of antigen retrieval processing, slide heaters were cooled in the conventional fashion followed by multiple solvent rinses and detection processing.

For the several fluids tested, approximately 5 ul of fluid was used to completely cover a tissue section. The first fluid tested was dubbed “IL-1”: 1-butyl-3-methylimidazolium 2-(2-methoxyethoxy)ethyl sulfate, Chemika A.S., Bratislava, Switzerland, P/N #67421. The second fluid tested was “IL-2”: 1-butyl-4-methylpyridinium tetrafluoroborate, Chemika A.S., P/N73261. The experiment used three slides per condition for IL-1 and two slides per condition for IL-2. A low vapor pressure amino glycol compound was also assessed, “A-1”: 3-amino-1,2-propanediol, 97%, Sigma-Aldrich, Inc., St. Louis, Mo., P/N A76001. The experiment ran two slides for 38 minutes and three slides for 98 minutes. The A-1 condition used a larger volume of fluid: ˜20-50 ul.

Before fluid application, slides were given a vigorous shake to remove the bulk of residual de-ionized water adhering to the slide surface post de-wax processing. A paper towel was used to blot excess droplets from the glass surrounding the tissue section. Care was taken to keep the tissue wet during this procedure. Once the low vapor pressure antigen retrieval fluid was applied, the slide was rotated to accelerate and ensure complete fluid coverage over the tissue section before the tissue had a chance to dry out. The slide was then placed onto a slide heater for protocol A processing. Table 3, below, summarizes the results.

TABLE 3

| | | | | Fluidic |
|---|---|---|---|---|
| Condition | Stain Intensity | Stain Uniformity | Morphology | stability |
| CC1 | Medium | good | Good | poor |
| Mild (42:00) | | | | |
| CC1 | Dark | good | Good | poor |
| Standard | | | | |
| (72:00) | | | | |
| IL-1 (38:00) | Medium | poor | Poor | good |
| IL-1 (68:00) | Dark | poor | Poor | good |
| IL-2 (38:00) | 0 | N/A | Good | good |
| IL-2 (68:00) | 0 | N/A | Good | good |
| A-1 (38:00) | Faint | good | Good | good |
| A-1 (98:00) | Dark | good | Fair | good |

As is evident from the two IL-1 entries in Table 3, above, IL-1 was effective at retrieving antigen, approximately equivalent to CC1 processing for similar time and temperature exposure conditions. But the IL-1 treatment degraded the morphology. Staining uniformity was also lacking; the pattern of non-uniformity was consistent between all IL-1 treated slides suggesting sensitivity to fixation artifacts not seen in the CC1 conditions. IL-2 chemistry exhibited no retrieval efficacy under the present conditions. Neither treatment effected tissue morphology. A-1 chemistry at 38 minutes exhibited retrieval efficacy, though less than CC1 chemistry. The 98-minute treatment condition suggested “over-retrieval”; i.e., there was degraded tissue morphology with maximized stain intensity. This result suggests that less treatment might not degrade the morphology as much while possibly still achieving (near) maximum stain intensity. Graph IV (FIG. 4) illustrates the relationship between percentage antigen retrieved and morphological degradation as a function of retrieval processing exposure. Graph IV Curves 1a and 1b (FIG. 4) represent CC1 Standard processing at time points T1 and T2. While stain intensity has reached a maximum, retrieval exposure is not so great as to cause morphological damage at these times. But if retrieval exposure lasted until time T₃, morphological damage would occur. Curves 2a and 2b (FIG. 4) represent IL-1 processing. Significant morphological damage occurs before complete antigen retrieval. Thus, some processing methods provide better antigen retrieval without causing corresponding excessive morphological damage.

Fluidic stability of the IL's and A-1 were all good: fast time to temperature; no observable fuming, out-gassing, bubbling, or bubble formation; no noticeable volume changes; +/−0.5 degrees C. set point temperature maintenance compared to several degrees drop with fluid refreshments of CC1 (as measured by the slide heater sensor).

### Example 6

### High Temperature Low Vapor Pressure Antigen Retrieval Fluids

Specialized software was implemented on a DISCOVERY® instrument providing high temperature processing up to 120 degrees C. True temperature (versus apparent) at the tissue surface is difficult to measure precisely; But higher temperature, as indicated by the heater sensor, correlated to higher tissue surface temperature however imprecisely that may be known. While CC1 antigen retrieval chemistry was more effective than A-1 chemistry at ˜100 degrees C. processing conditions (as demonstrated in Example 5), CC1 chemistry became impractical as temperature approaches the boiling point of the solution resulting in serious fluidic instability issues, whereas low or no vapor pressure fluids do not suffer from this limitation. Further, processing at temperatures above 100 degrees C. may enhance a particular process.

Slides were obtained from Tissue Block C. Two slides were processed per CC1, IL-2, and glycerol (99%, Sigma-Aldrich P/N G-5516) conditions using the process described in Example 5 following the details listed in Table 4, below. Glycerol was applied in excess in volumes of ˜50-100 ul. Two slides were processed with A-1 low vapor pressure antigen retrieval fluid at 115 degrees C. conditions; 4 slides each for the 12 and 16 minute 120 degrees C. conditions using the process described in Example 5. Table 4, below, shows the results. Both IL-2 and glycerol are not useful antigen retrieval chemistries at the current protocol settings because there use produced no staining. Neither did their use degrade morphology. A-1 processing at temperatures above 100 degrees C. demonstrated accelerated reaction times for antigen retrieval compared to CC1 processing at 100 degrees. Furthermore, fluidic stability was good at elevated temperatures for A-1. At 16 minutes for A-1, stain intensity was maximized (dark) with slight morphological degradation on one slide. At 12 minutes, one slide looked slightly under-retrieved (medium stain). Since it takes ˜10 minutes for slide heaters to reach set point temperature, short processing cycles of only slightly more than 10 minutes may experience temperature variance, unlike longer cycle processes where variances average over time. Actual reaction time once at set point temperature may be quite short for effective retrieval, on the order of a few minutes at 120 degrees C. for A-1. Fluidic stability was good for all conditions using low or no vapor pressure fluids.

TABLE 4

| | Temp- | | | | | |
|---|---|---|---|---|---|---|
| | erature | Time | Stain | Stain | Morph- | Fluidic |
| Fluid | deg. C. | min | Intensity | Uniformity | ology | stability |
| CC1 | 100 | 42 | medium | good | Good | poor |
| CC1 | 100 | 72 | dark | good | good | poor |
| IL-2 | 120 | 38 | 0 | N/A | good | good |
| IL-2 | 120 | 68 | 0 | N/A | good | good |
| A-1 | 115 | 24 | dark | good | good | good |
| A-1 | 120 | 16 | dark | good | good- | good |
| | | | | | fair | |
| A-1 | 120 | 12 | med- | good | good | good |
| | | | dark | | | |
| Glycerol | 120 | 40 | 0 | good | good | good |

### Example 7

### A-2/A-3 High Temperature Antigen Retrieval

Two other fluid compounds from the aminopolyol family were evaluated for antigen retrieval using the process described in Example 5: triethanolamine (“A-2”: Sigma-Aldrich P/N T5830-0, BP=193 degrees C.) and diethanolamine (“A-3”: Sigma-Aldrich P/N D8330-3, BP=217 degrees C./150 mm Hg). Two slides per condition from Tissue Block C were processed, as listed in Table 5, below. A-2 was not effective for retrieval under the present conditions. A-3 was effective, though not as effective as A-1, requiring greater processing to attain equivalent retrieval effect. A-1 at 120 degrees C. for 20 minutes was over-retrieved exhibiting significant morphological damage. Table 5, below, summarizes the results.

TABLE 5

| | Temperature | Time | Stain | Stain | Morph- | Fluidic |
|---|---|---|---|---|---|---|
| Fluid | degrees C. | min | Intensity | Uniformity | ology | stability |
| A-1 | 120 | 20 | dark | good | poor | good |
| A-3 | 120 | 16 | light | fair | good | good |
| A-3 | 120 | 20 | medium | fair | good | good |
| A-3 | 120 | 24 | dark | good | good | good |
| A-2 | 120 | 16 | 0 | N/A | good | good |
| A-2 | 120 | 20 | 0 | N/A | good | good |
| A-2 | 120 | 24 | 0 | N/A | good | good |
| A-2 | 120 | 40 | 0 | N/A | good | good |

### Example 8

### Antigen Retrieval Without De-wax Processing (De-Wax Free)

Unlike the previous examples, slides were processed without previous off-line de-wax pre-processing. Approximately 20-50 ul of A-1 fluid was applied directly onto the center of the waxy tissue section on each slide. Because of the polar nature of the fluids and the non-polar nature of the paraffin sections, the fluid drop was applied directly to the center region of the wax section fully covering the tissue. The relatively high viscosity of the A-1 fluid facilitated stability of the drop, as long as the drop was well centered. If the drop came too close to the waxy edge and touched any of the surrounding naked glass, surface tension forces pulled the polar fluid off the wax and onto the glass surface, leaving the tissue section uncovered and untreated. This is a highly unstable and impractical fluidic condition under which to operate. Once the slides had been heated and the wax had melted, the fluids appeared to stabilize.

Nine slides were obtained from Tissue Block A. Six slides were de-waxed off-line, as before, and three were not. Of the six slides, three remained in 100% ethanol solution during de-waxing avoiding further solvent exchanging down to de-ionized water. Thus, immediately before antigen retrieval processing, three slides were de-waxed and hydrated, three were de-waxed in 100% ETOH, and three were embedded in paraffin wax.

The protocol was adjusted to cool the slides to 75 degrees C. after antigen retrieval, but before rinsing to remove wax. After one rinse cycle, the slides naturally cooled to ambient temperature while awaiting further processing. The antigen retrieval process had a reaction temperature of 120 degrees C. and a reaction time of 20 minutes. All exhibited over-retrieval resulting in a “poor” morphological score. Table 6, below, summarizes the results.

TABLE 6

| | | Stain | | |
|---|---|---|---|---|
| State | Stain Intensity | Uniformity | Morphology | Fluidic stability |
| H₂O | dark | Good | poor | good |
| ETOH | dark | Good | poor | good |
| WAX | dark | Good | poor | poor |

Barring fluidic instabilities under the process of this example using the A-1 tissue conditioning fluid, the separate de-wax pre-processing operations can be eliminated thereby providing further accelerated processing. This may be called a “de-wax free” antigen retrieval process.

### Example 9

### De-Wax Free Using IL-1, A-1 and A-3

Slides were processed at 120 degrees C. using the de-wax free process described in Example 8. The process used ˜20-70 ul of IL-1, A-1, and A-3 fluids on slides from Tissue Block C. An additional two slides that had been previously off-line dewax processed, underwent the retrieval process with IL-1. Only a few cells accepted staining, which indicates that the presence of wax harmed IL-1 retrieval. Wax apparently did not harm the A-1 and A-3 retrievals. Table 7, below summarizes the results.

TABLE 7

| State | Fluid | Time | Stain Intensity | Stain Uniformity | Morphology |
|---|---|---|---|---|---|
| WAX | IL-1 | 16 | ~0 | N/A | poor |
| H₂O | IL-1 | 16 | medium | good | poor |
| WAX | A-1 | 14 | dark | good | good |
| WAX | A-3 | 24 | dark | good | good |

### Example 10

### Solutions of A-1

The viscosity of the aminopolyols is sufficiently high to impede its ability to be pumped, e.g., through small diameter tubing. In the present example, A-1 received de-ionized water to reduce the solution's viscosity. Both 50% and 10% (v/v) concentrations of A-1 in water were formulated. Water and A-1 are both polar and readily mix with each other. Both the 50% and 10% formulations exhibited viscosities similar to that of water. Three slides per condition (120 C) were processed using the de-wax free process described in Example 8 using ˜50-200 ul fluid volumes of 10% and 50% A-1 on slides from Tissue Block C. For the 10% condition, 200 ul volumes were applied, and the slides were treated for 12 minutes. For the 50% condition, ˜50-100 ul volumes were applied, and the slides were treated for 20 minutes. The lower viscosity facilitated fluid transport and fluid applications. But the lower viscosity contributed to even higher fluidic instabilities; fluid more readily flowed and was more susceptible to migration off the wax section and onto the surrounding glass regions. Greater care was required to ensure that retrieval fluid droplet stayed within the waxy section until the wax melted. Smaller volumes of retrieval fluid were less prone to migration; larger bodies were more prone to inertial and gravity effects that destabilized fluid positioning on slides.

Another effect of adding water was that slides took longer to reach set point temperature of 120 degrees C. as energy and time were required to vaporize the water. No gas bubble formation was observed; slides were fluidically stable in this regard. But volumes changed as water vaporized such that slides were not fluidically stable in this regard. The 10% formulations lost significant volumes through this process. Residual solution did not uniformly cover the tissue, which manifested as non-uniform staining. But where the fluid covered the tissue, the tissue stained darker. Therefore, mixing A-1 with water succeeded to “thin” the retrieval fluid for fluid trans-port without harming the effectiveness of the retrieval process. But significant fluidic instabilities remained caused by water evaporating during the process.

### Example 11

### Membrane Fluidic Control

A 12″×25″ sheet of 0.002″ thick Kapton™ membrane (McMasterCarr Supply Company, Los Angeles, Calif.: 12″×25″ P/N 2271 K12) was cut into 2.5×5 cm size pieces. Several slides of waxy tissue sections were obtained from Tissue Block C. In the first case, a waxy tissue section mounted on a glass slide was presented face up and a 100 ul drop of de-ionized water was applied. The water drop formed an unstable bead when applied to the waxy surface due to the non-polar nature of the wax in contrast to the polar nature of the fluid. Instability manifested as a tendency for the water drop to migrate and sometimes fall from the glass surface upon moving or tilting the glass. In the second case, a Kapton™ membrane piece was presented face up and a 100-ul drop of de-ionized water was applied. The water drop adhered to the Kapton™ surface and resisted migration. The Kapton™ surface provided a more fluidically stable base for capturing the fluid drop. Next, the glass slide was placed onto the drop of fluid with the waxy surface directly in contact with the fluid. The fluid spread and completely covered the space between the membrane and glass as they touched. The presence of the non-polar waxy surface did not impede the coverage of fluid across the contacting region. The Kapton™ surface dominated and controlled the fluid dynamics, providing fluidic stability.

### Example 12

### Fluidic Control and A-1 Antigen Retrieval

Nine slides containing waxy sections from Tissue Block C were processed using A-1 formulations and the 120° C. 16:00 retrieval protocol. 200 ul of A-1 100% was applied carefully to the center tissue region of the waxy section on three slides. Another three slides received 200 ul of 100% A-1 and another three received 100 ul of 50% A-1. For these last 2 groups, a piece of Kapton™ was placed directly onto the slide immediately after A-1 fluid application (and before slide heating) in order to provide complete coverage of the fluid across the slide. After retrieval processing, membranes were removed during the cooling period to provide continued processing without membrane interference. Applying these thin and flexible membranes included bending the membranes as they are placed onto the fluid to prevent bubbles from being trapped under the membrane and to allow the fluid to spread between the two elements. Further, membrane removal uses similar bending for low stress removal of the wetted membranes. Upon contacting and release of the membranes, they spontaneously flattened out due to surface tensions thereby providing even distribution and coverage of fluid between the elements.

TABLE 8

| | | Stain | Stain | Morph | Fluidic |
|---|---|---|---|---|---|
| Condition | Membrane | Intensity | Uniformity | ology | Stability |
| 100% A-1 | No | dark | good | good | Unstable |
| 100% A-1 | Yes | dark | good | good | Stable |
| 50% A-1 | Yes | dark | good | poor | Unstable |

Results (summarized in Table 8, above) were indistinguishable between membrane cases versus no membrane 100% A-1 cases. The membrane provided assurance of fluidic coverage across the surface of the glass slide regardless of non-polar regions. While the 50% case provided good staining and uniformity results, it proved to be fluidically unstable. As the slides reached the boiling point of the fluid, gas pockets formed beneath the membrane causing membrane “popping” motions. The resulting morphological damage was severe: presumably, local, gas-pocket-driven shear stress loading of the native tissue disrupted the native tissue structure. In the non-membrane (uncovered) cases of this Example and previous examples, water is free to volatilize unhindered and without associated effect on tissue morphology.

### Example 13

### High Temperature Pre-Heating and Effect on Antigen Retrieval Time

When heating slides using the DISCOVERY® system for 14-20 minutes to affect antigen retrieval, reaching set point temperature consumes much of the process time (˜10 minutes). If both the heater surface and the fluid drop were preheated, effective reaction time could be significantly reduced. Two slides per condition were obtained from Tissue Block C. Four slides were off-line de-waxed and four slides were not. Several slide heaters (see FIG. 1) were programmed to stay at a constant temperature of 120 degrees C. for a minimum of 10 minutes before use. All slide heaters were thoroughly cleaned with detergent followed by de-ionized water rinsing, before use. About 50-100 ul of A-1 fluid was applied directly to the preheated slide heaters. The procedure allowed an additional 30 seconds and 2 minutes to pre-heat the applied fluid. Slides were placed tissue surface face down into the preheated fluids. The fluid spread providing coverage upon contact. Slides were treated for either 4 or 6 minutes. Once treated, slides were removed from slide heaters, allowed to cool suspended in air for ˜10 seconds and placed tissue-side up onto preheated slide heaters at 75 degrees C. Afterwards, processing was completed through detection (reported in Table 9, below).

TABLE 9

| | | Stain | Stain | | Fluidic |
|---|---|---|---|---|---|
| State | Time | Intensity | Uniformity | Morphology | Stability |
| H₂O | 4 minutes | dark | good | good | Stable |
| H₂O | 6 minutes | dark | good | good | Stable |
| WAX | 4 minutes | dark | poor | good | Stable |
| WAX | 6 minutes | dark | poor | good | Stable |

The pre-de-waxed slides showed good retrieval at short reaction times under preheated retrieval processing demonstrating more expedient processing partially through minimized thermal lag effects. The wax-embedded slides exhibited non-uniform stain due to incomplete coverage. In previous examples, the retrieval fluid was placed on top of the tissue. In the present case, the orientation is reversed, the slide is inverted, and the tissue is placed downwards onto the preheated fluid. It appears that positioning influences the retrieval fluid's ability access the tissue when wax is present. Alternatively, with appropriately oriented apparatuses, a heating element may be placed above the tissue sample providing appropriate staining results. Or the slide could be reciprocated (agitated) in a back and forth motion with respect to the heating element to facilitate fluid access to tissue.

### Example 14

A first heater station, fluid contacting surface (see FIG. 5A) is preheated to a set point temperature, e.g., 120 degrees C. 100 ul of an antigen retrieving fluid of the present invention was applied to the first heater surface and a tissue mounted slide 14 was placed on the fluid for rapid antigen retrieval treatment. Following treatment, the slide 14 was removed from the first surface 22 and contacted with a second heated treatment surface 24 for subsequent treatment. The first and second treatment surfaces may be contiguous regions 22, 24 of the same component (FIG. 5A) or alternatively may be discrete surfaces 22, 24 of separate heated surfaces (FIG. 5B). Alternatively, only a first treatment surface is used, e.g., for antigen retrieval wherein a low vapor pressure retrieval fluid inhibits drying and, thus, not requiring immediate rinsing.

### Example 15

### Ki67 on Breast on DISCOVERY® Autotimer Using Automated Antigen Retrieval

High-temperature-fluid antigen retrieval on human breast tissue was evaluated using the process described in Example 1. Tissue Block D contained a piece of paraffin-embedded, neutral-buffered, formalin-fixed human breast tissue. The block was micro-sectioned in approximately 4 micron thick sections, one section mounted per slide. One slide each was stained following treatment with one of the following cell conditioning fluids: (1) 3-amino-1,2-propanediol diluted with de-ionized water to 50% concentration by volume; (2) concentrated high-temperature LIQUID COVERSLIP™ (LCS) which is a paraffinic hydrocarbon oil obtained from Ventana Medical Systems, Inc., Tucson, Ariz. (Catalog No. 650-010); or (3) LCS applied in a covering layer to the tissue bathed in EZ Prep, also available from Ventana Medical Systems, Inc. of Tucson, Ariz. (Catalog No. 950-102). The EZ Prep, which is sold as a 10× concentrate, was diluted 1:10 by volume with de-ionized water before use.

The slides were processed at 115 degrees C. for various times before staining.

In most cases, a significant loss of tissue, a problem common with collagenous loose connective tissue, particularly prevalent in breast tissue, was observed, and particularly so with aminopolyol processing. But for tissue that did adhere, excellent antigen retrieval was observed. Slides were held for 12, 16, 20, and 40 minutes at 115 degrees C. Table 10, below, report the results.

TABLE 10

| | Stain | | |
|---|---|---|---|
| Conditioning Fluid | Intensity | Stain Uniformity | Morphology |
| CC1 | dark | good | poor |
| 3-amino-1,2-propanediol | dark | fair to good | good |
| LCS | medium-dark | fair | good |
| LCS + EZ Prep | dark | fair | fair to good |

### Example 16

One application of this technique is to a de-waxed formalin fixed tissue sample where one wishes to increase the recognition of particular antigen that has been lost due to fixation. In this example, a “high-boiling point fluid” is first preheated to 140 degrees Celsius in a vessel that contains 40-100 ml of the solution. A De-waxed slide containing a thin section of Human tonsil is immersed in the fluid such that the tissue section is completely covered by the fluid. After 5 minutes of incubation, the slide is removed and placed into room temperature buffer to allow the slide to cool rapidly and stop the AR process. The tonsil slide is then stained for Ki-67 antigen using a standard DAB process.

### Comparative Example 1

In another process, the tonsil slide is placed into a Single Slide Processor whereby the tissue is face down in the holder. The tissue is suspended above the floor of the device by rails that run along the sides of the processor. The chamber that is created is filled with approximately 400 mL of retrieval solution. The Single Slide Processor is placed on top of a heating device, such as a pelltier-type heat pump that can aftain a temperature of at least 125 degrees Celsius. In this example, the device is heated to 125 degrees for 20 minutes. After 20 minutes of incubation, the slide is removed and placed into room temperature buffer to allow the slide to cool rapidly and stop the AR process. The tonsil slide is then stained for Ki-67 antigen using a standard DAB process.

### Example 17

The examples in Table 11, below used the following procedure for tissue conditioning. First, a retrieval solution was prepared. A platen was preheated to a reaction temperature. Afterwards, a slide with a mounted tissue sample (slide and sample previously de-waxed) were placed onto the heated platen tissue side down. A reaction volume of retrieval solution was injected under the slide between the platen and the slide. After the solution was injected, the system was incubated for a reaction time.

Cell Conditioning Fluid A (10×): 100 mM Tris, 74 mM BoricAcid, 10 mM EDTA and 10% Tween 20.

10×TBE: 890 mM Tris-borate and 20 mM EDTA, pH 8.3.

Retrieval solution formulation I was prepared by mixing an appropriate amount of guanidinium thiocyanate with propylene glycol to form a 2 molar solution of guanidinium thiocyanate.

Retrieval solution formulation II was prepared by mixing an appropriate amount of guanidinium thiocyanate with propylene glycol to form a 3 molar solution of guanidinium thiocyanate.

Retrieval solution formulations III and IV were prepared by mixing an appropriate amount of guanidinium thiocyanate and N-lauryl sarcosine with propylene glycol to form a solution with a 2 molar (formulation III) or 3 molar (formulation IV) concentration of guanidinium thiocyanate and enough n-lauryl sarcosine to bring each formulation to a 1% concentration of N-lauryl sarcosine.

Retrieval solution formulation V was prepared by mixing a 1:1 proportion of ethylene glycol and Cell Conditioning Fluid A (10×) and placing the mixture into a preheated oven (150 degrees C.) and allowing the water to evaporate.

Retrieval solution formulation VI was prepared diluting Cell Conditioning Fluid A (10×) to make Cell Conditioning Fluid A (5×) and then mixing a 1:1 proportion of ethylene glycol and Cell Conditioning Fluid A (5×) and placing the mixture into a preheated oven (150 degrees C.) and allowing the water to evaporate.

Retrieval solution formulation VII was prepared by mixing a 1:1 proportion of propylene glycol and Cell Conditioning Fluid A (10×) and placing the mixture into a preheated oven (150 degrees C.) and allowing the water to evaporate. Alternatively, formulation VII was prepared by mixing 200 ml propylene glycol and 200 ml cell condition fluid A (10×) and rotovapping the mixture for approximately 45 minutes at 65 degrees C. (total volume after evaporation was 230 ml.)

Retrieval solution formulation VIII was prepared by mixing 200 ml propylene glycol and 200 ml 10×TBE and rotovapping the mixture for approximately 45 minutes at 65 degrees C. (total volume after evaporation was 230 ml.)

Retrieval solution formulation IX was prepared by mixing 200 ml propylene glycol and 200 ml 10×TBE and rotovapping the mixture for approximately 45 minutes at 65 degrees C. (total volume after evaporation was 205 ml.). Afterwards, approximately 1 ml of Tween 20 was added.

Retrieval solution formulation X was prepared by mixing an appropriate amount of guanidinium thiocyanate and urea with propylene glycol to form a solution that was 2 molar guanidinium thiocyanate and 2.5 molar urea.

Retrieval solution formulation XI was prepared by mixing an appropriate amount of glycerol and cell conditioning fluid A (10×) diluted to (0.5×) to form a 1:1 mixture of glycerol and cell conditioning fluid A (0.5×).

TABLE 11

| Retrieval | Reaction | Reaction | Reaction | |
|---|---|---|---|---|
| Solution | temp ° C. | time min | vol μl | Stain Quality/Morphology |
| I | 120 | 10 | 100 | Some staining seen (light), showed promising results for BCL-2 |
| I | 120 | 20 | 100 | Some staining seen (light), showed promising results for BCL-2 |
| I | 130 | 10 | 100 | Some staining seen (light), showed promising results for BCL-2 |
| I | 130 | 20 | 100 | Some staining seen (light), showed promising results for BCL-2 |
| I | 140 | 5 | 100 | Gave overall best staining and morphology. |
| I | 140 | 10 | 100 | Gave overall best staining and morphology. |
| I | 140 | 15 | 100 | Gave overall best staining and morphology. |
| II | 120 | 10 | 100 | Some staining seen (light), showed promising results for BCL-2 |
| II | 120 | 20 | 100 | Some staining seen (light), showed promising results for BCL-2 |
| II | 125 | 10 | 100 | Some retrieval, very light staining (rind effect), good morphology |
| II | 125 | 20 | 100 | Some retrieval, very light staining (rind effect), good morphology |
| II | 130 | 10 | 100 | Some staining seen (light), showed promising results for BCL-2 |
| II | 130 | 20 | 100 | Some staining seen (light), showed promising results for BCL-2 |
| II | 140 | 5 | 100 | Gave overall best staining and morphology. |
| II | 140 | 10 | 100 | Gave overall best staining and morphology. |
| II | 140 | 15 | 100 | Gave overall best staining and morphology. |
| III & IV | 140 | 5, 15 | 100 | No staining was observed |
| V | 120 | 10 | 100 | Decreased stain quality compated to 140 degrees C at 10 min, |
| | | | | but less background staining |
| V | 125 | 5 | 100 | Some areas of tissue showing promising stain quality and other |
| | | | | areas of tissue very little staining |
| V | 140 | 2.5 | 100 | Some retrieval |
| V | 140 | 5 | 100 | Increase stain compared to 2.5 |
| V | 140 | 10 | 100 | Equal stain quality to 2.5 with some background staining |
| V | 140 | 15 | 100 | Equal stain quality to 2.5 with some background staining |
| V | 140 | 20 | 100 | Stain and morphology started to degrade |
| VI | 140 | 5 | 100 | Some retrieval |
| VI | 140 | 10 | 100 | Acceptable staining |
| VII | 135 | 10 | 100 | Low stain quality |
| VII | 140 | 10 | 100 | Low stain quality with increased background staining |
| VIII | 140 | 10 | 100 | Low stain quality with increased background staining. |
| IX | 140 | 10 | | Good stain quality compared to propylene glycol with 10x TBE |
| | | | | (without surfactant); stain quality reduced compared to control |
| | | | | slides using a standard retrieval method |
| X | 125-140 | 20 | 100 | No staining |
| X | | 30 | 100 | Some staining |
| XI | 110 | 5, 10 | Large volume | Retrieval reported at 5 & 10 minutes with CC1 added. No retrieval |
| | | | | with 50% glycerol in water. |

Various changes may be made in the foregoing. For example, the fluid contacting surface may comprise a membrane in contact with a heater station. The membrane may be incremented with respect to the heater surface or the slide surfaces such that a fresh membrane surface is made available for each processed slide. Further, the processing station may be elongated such that a number of slides may be sequentially and simultaneously processed as they move along the station. In such case, the slides may be continuously fed into the station, and, after an initial wait time to raise the temperature of the slides, the slides may be continuously processed through the station. Other changes may be made without departing from the spirit and scope of the invention.

While particular embodiments of the present invention have been shown and described, it will be obvious to those skilled in the art that changes and modifications can be made without departing from the embodiments of this invention in its broader aspects and, therefore, the appended claims are to encompass within their scope all such changes and modifications as fall within the true spirit and scope of the embodiments of this invention. Additionally, various embodiments have been described above. For convenience's sake, combinations of aspects composing invention embodiments have been listed in such a way that one of ordinary skill in the art may read them exclusive of each other when they are not necessarily intended to be exclusive. But a recitation of an aspect for one embodiment is meant to disclose its use in all embodiments in which that aspect can be incorporated without undue experimentation. In like manner, a recitation of an aspect as composing part of an embodiment is a tacit recognition that a supplementary embodiment exists that specifically excludes that aspect. All patents, test procedures, and other documents cited in this specification are fully incorporated by reference to the extent that this material is consistent with this specification and for all jurisdictions in which such incorporation is permitted.

Moreover, some embodiments recite ranges. When this is done, it is meant to disclose the ranges as a range, and to disclose each and every point within the range, including end points. For those embodiments that disclose a specific value or condition for an aspect, supplementary embodiments exist that are otherwise identical, but that specifically exclude the value or the conditions for the aspect.

What is claimed is:

1. A method comprising
mounting a preserved tissue sample adjacent a capillary gap and
applying a mixture comprising a tissue conditioning fluid at a reaction temperature for a reaction time to the capillary gap.

2. The method of claim 2 wherein the reaction time is long enough to condition the preserved tissue sample for analysis.

3. The method of claim 2 wherein the reaction time is 1 to 30 minutes.

4. The method of claim 2 wherein the reaction time is 5 to 25 minutes.

5. The method of claim 2 wherein the reaction time is 10 to 20 minutes.

6. The method of claim 1 wherein the reaction temperature ranges from 100 to 160 degrees C.

7. The method of claim 6 wherein the reaction temperature ranges from 120 to 160 degrees C.

8. The method of claim 2 wherein the reaction temperature ranges from 100 to 160 degrees C.

9. The method of claim 5 wherein the reaction temperature ranges from 120 to 160 degrees C.

10. The method of claim 1 wherein the method is conducted at ambient pressure.

11. The method of claim 2 wherein the method is conducted at ambient pressure.

12. The method of claim 8 wherein the method is conducted at ambient pressure.

13. The method of claim 9 wherein the method is conducted at ambient pressure.

14. The method of claim 1 wherein the tissue conditioning fluid comprises aminopolyols, glycerol, ethylene glycols, propylene glycols, poly(ethylene glycols), poly(propylene glycols), or aliphatic alcohols.

15. The method of claim 8 wherein the tissue conditioning fluid comprises aminopolyols, glycerol, ethylene glycols, propylene glycols, poly(ethylene glycols), poly(propylene glycols), or aliphatic alcohols.

16. The method of claim 13 wherein the tissue conditioning fluid comprises aminopolyols, glycerol, ethylene glycols, propylene glycols, poly(ethylene glycols), poly(propylene glycols), or aliphatic alcohols.

17. The method of claim 14 wherein the tissue conditioning fluid comprises a chaotropic agent.

18. The method of claim 15 wherein the tissue conditioning fluid comprises a chaotropic agent.

19. The method of claim 16 wherein the tissue conditioning fluid comprises a chaotropic agent.

20. The method of claim 17 wherein the chaotropic agent comprises I⁻, ClO₄⁻, SCN⁻, Li⁺, Mg²⁺ Ca²⁺, Ba²⁺, or Gu⁺

21. The method of claim 1 wherein the boiling point of the fluid is greater than 180 degrees C.

22. The method of claim 9 wherein the boiling point of the fluid is greater than 180 degrees C.

23. The method of claim 14 wherein the boiling point of the fluid is greater than 180 degrees C.

24. The method of claim 19 wherein the boiling point of the fluid is greater than 180 degrees C.

25. The method of claim 24 wherein the boiling point of the fluid is greater than 200 degrees C.

26. The method of claim 1 wherein the mixture experiences a volume loss during the reaction wherein the volume loss is less than 50 percent.

27. The method of claim 9 wherein the mixture experiences a volume loss during the reaction wherein the volume loss is less than 50 percent.

28. The method of claim 14 wherein the mixture experiences a volume loss during the reaction wherein the volume loss is less than 50 percent.

29. The method of claim 17 wherein the mixture experiences a volume loss during the reaction wherein the volume loss is less than 50 percent.

30. The method of claim 24 wherein the mixture experiences a volume loss during the reaction wherein the volume loss is less than 50 percent.

31. The method of claim 1 wherein the mixture experiences a volume loss during the reaction wherein the volume loss is less than 10 percent.

32. The method of claim 14 wherein the mixture experiences a volume loss during the reaction wherein the volume loss is less than 10 percent.

33. The method of claim 17 wherein the mixture experiences a volume loss during the reaction wherein the volume loss is less than 10 percent.

34. The method of claim 1 wherein condition tissue comprises antigen retrieval and target retrieval occurring during the same analysis.

35. The method of claim 9 wherein condition tissue comprises antigen retrieval and target retrieval occurring during the same analysis.

36. The method of claim 14 wherein condition tissue comprises antigen retrieval and target retrieval occurring during the same analysis.

37. The method of claim 17 wherein condition tissue comprises antigen retrieval and target retrieval occurring during the same analysis.

38. The method of claim 24 wherein condition tissue comprises antigen retrieval and target retrieval occurring during the same analysis.

39. The method of claim 30 wherein condition tissue comprises antigen retrieval and target retrieval occurring during the same analysis.

40. The method of claim 1 further comprising a heated platen wherein the heated platen is adjacent the capillary gap.

41. The method of claim 2 further comprising a heated platen wherein the heated platen is adjacent the capillary gap.

42. The method of claim 9 further comprising a heated platen wherein the heated platen is adjacent the capillary gap.

43. The method of claim 17 further comprising a heated platen wherein the heated platen is adjacent the capillary gap.

44. A method comprising applying a mixture of propylene glycol and guanidinium thiocyanate at a reaction temperature to a preserved tissue sample for a reaction time wherein the reaction temperature ranges from 100 to 160 degrees C.

45. The method of claim 44 wherein the reaction time is long enough to condition the preserved tissue sample for analysis.

46. The method of claim 45 reaction time is 10 to 20 minutes.

47. The method of claim 45 wherein the method is conducted at ambient pressure.

48. The method of claim 47 wherein analysis is immunohistochemical analysis or in-situ hybridization.

49. The method of claim 48 wherein the boiling point of the fluid is greater than 180 degrees C.

50. A composition comprising
water
propylene glycol and
guanidinium thiocyanate
wherein the concentration of water is less than 10 percent (v/v) and the concentration of guanidinium thiocyanate is 2 to 3 molar overall.

51. The composition of claim 50 consisting essentially of
water
propylene glycol and
guanidinium thiocyanate
wherein the concentration of water is less than 10 percent (v/v) and the concentration of guanidinium thiocyanate is 2 to 3 molar overall and
wherein the composition is adapted for tissue conditioning.
